(19) United States
(12) Patent Application Publication
(10) Pub. No.: US 2019/0005630 A1
(43) Pub. Date: Jan. 3, 2019

(54) High Dynamic Range Image Processing Method and Apparatus

(71) Applicant: Huawei Technologies Co., Ltd., Shenzhen (CN)

(72) Inventors: Meng Li, Beijing (CN); Hai Chen, Shenzhen (CN)

(21) Appl. No.: 16/126,754

(22) Filed: Sep. 10, 2018

Related U.S. Application Data
(63) Continuation of application No. PCT/CN2016/075989, filed on Mar. 9, 2016.

(51) Int. Cl. G06T 5/00; G09G 3/34; H04N 19/30

(52) U.S. Cl. CPC G06T 5/009; H04N 19/30; G09G 3/3426

(57) ABSTRACT

A high dynamic range image processing method and apparatus to resolve a problem of displayed-image distortion, where the method includes obtaining a high dynamic range image, dividing the high dynamic range image into a first liquid crystal image and a first backlight image, performing compression processing on the first liquid crystal image by decreasing a quantity of bits representing a single pixel of the first liquid crystal image to obtain a compressed first liquid crystal image to be displayed at a liquid crystal layer of a display, where the display is configured to display the high dynamic range image, and performing compression processing on the first backlight image by decreasing a quantity of bits representing a single pixel of the first backlight image to obtain a compressed first backlight image to be displayed at a backlight layer of the display.

### CROSS-REFERENCE TO RELATED APPLICATIONS

This application is a continuation of International Patent Application No. PCT/CN2016/075989 filed on Mar. 9, 2016, which is hereby incorporated by reference in its entirety.

### TECHNICAL FIELD

Embodiments of the present application relate to the field of image processing technologies, and in particular, to a high dynamic range image processing method and apparatus.

### BACKGROUND

A dynamic range represents a ratio of a maximum grayscale value to a minimum grayscale value in a displayable range of an image. Currently, in most color digital images, each of channels red (R), green (G), and blue (B) is stored using one byte, that is, 8 bits. To be specific, when a representation range of each channel is grayscale levels from 0 to 255, a dynamic range of an image is 0 to 255. However, a dynamic range in a same scenario in the real world is within a range from 10⁻³ nits to 10⁶ nits, and the range is referred to as a high dynamic range (also referred to as HDR). A high dynamic range image (also referred to as HDRI) is an image type that can represent a light luminance range change in an actual scenario. Therefore, optical characteristics of a bright region and a dark region in the scenario can be better represented. A pixel value range to be represented by the high dynamic range image is usually extremely large, and sometimes needs to be hundreds of thousands or even millions. Each color channel of the high dynamic range image requires more data bits than a conventional image because of linear coding of the high dynamic range image and a need to represent a value in a luminance range visible to human eyes or an even larger range. A high dynamic range pixel is often indicated using a 16-bit half-precision floating point number or a 32-bit floating point number.

An imaging process of an image on a display is actually mapping from high dynamic range light information in the real world to low dynamic range light information of a displayed image on the display, and is a nonlinear process, as shown in FIG. 1. Tone mapping is currently a commonly used method for converting a high dynamic range image into a low dynamic range image, and provides a method for mapping a luminance value in a real scenario to a range that can be displayed on a display.

A high dynamic range display is popularly explained as a display with a higher peak pixel value, a lower black spot (minimum pixel value), and a larger contrast. Displays may be classified into a light emitting diode (LED) backlight display, a plasma display, a laser display, and the like based on backlight differences. The LED backlight display is currently the most widely used display. A dynamic range of a conventional LED backlight device is only 10⁻¹ to 10³ nits. This relatively small dynamic range greatly affects quality of a displayed image. The dynamic range of the display can be increased by increasing backlight intensity. However, because severe light leakage exists in a liquid crystal display, only increasing a maximum backlight luminance value cannot be satisfactory. For example, if the maximum backlight luminance value is increased to 1000 nits, luminance of a minimum black spot increases accordingly and may be, for example, 0.5 nit. In this case, the dynamic range is 1000:0.5=2000. The backlight intensity is increased by 10 times, but the dynamic range is only doubled. Therefore, a new solution is required, and local dimming is a relatively common method. A display using this method may display an HDR image using non-uniform backlight. Further, backlight intensity on different regions of a screen may be adjusted based on an input image. A display that can implement local dimming is usually a double-layer structure, and includes a backlight layer and a liquid crystal layer, as shown in FIG. 2. The backlight layer can perform different dimming based on different partitions. A backlight layer image may be equivalent to a low-resolution image, and a liquid crystal layer image is equivalent to a high-resolution image. The backlight layer image and the liquid crystal layer image are combined to obtain an image that includes complete information.

The high dynamic range image needs to be processed before being displayed on the display. Currently, used processing is usually as follows. First, an HDR image (for example, 16 bits) is compressed using a tone mapping method into a dynamic range (8 or 10 bits) that can be displayed on an existing display, then layer division processing is performed on an image of 8 or 10 bits to obtain a backlight layer image and a liquid crystal layer image, and then dimming is performed on the backlight layer image, the liquid crystal layer image is compensated for, and the two layer images are fused to obtain a final image that can be displayed on the display. However, in a currently used processing solution, an image first needs to be compressed using a tone mapping algorithm such that a 16-bit HDR image source is compressed into an image of 8 or 10 bits. Therefore, an obtained image used for processing of a local dimming module is a compressed low-bit image, and a finally displayed image effect is used to simulate the low-bit image, but is not the original HDR image source. Consequently, a displayed image may not be consistent with an original HDR image, and image distortion is caused.

### SUMMARY

Embodiments of the present application provide a high dynamic range image processing method and apparatus, to resolve a other approaches problem of displayed-image distortion.

According to a first aspect, an embodiment of the present application provides a high dynamic range image processing method, and the method includes obtaining a high dynamic range image, dividing the high dynamic range image into a first liquid crystal image and a first backlight image, performing compression processing on the first liquid crystal image by decreasing a quantity of bits used to represent a single pixel of the first liquid crystal image, to obtain a compressed first liquid crystal image to be displayed at a liquid crystal layer of a display, where the display is configured to display the high dynamic range image, and performing compression processing on the first backlight image by decreasing a quantity of bits used to represent a single pixel of the first backlight image, to obtain a compressed first backlight image to be displayed at a backlight layer of the display.

In a conventional HDR processing technology, compression processing is first performed on an HDR image and then backlight control processing is performed. In this way, a large quantity of image details of a displayed HDR image are lost. Backlight control processing is performed on a compressed image, and therefore the backlight control processing can only be used to simulate the compressed image in a processing process. This may result in inconsistency between a finally processed displayed image and the original HDR image. In this embodiment of the present application, layer division processing is directly performed on the HDR image, and then backlight control processing is performed on a backlight image obtained after layer division such that loss of a large amount of detail information due to compression can be avoided.

In a possible design, performing compression processing on the first liquid crystal image by decreasing a quantity of bits used to represent a single pixel of the first liquid crystal image may be implemented in the manner of dividing the first liquid crystal image into at least two layers of second liquid crystal images, where the at least two layers of second liquid crystal images include image information of the first liquid crystal image, and any two of the at least two layers of second liquid crystal images include different image information, separately performing compression processing on the at least two layers of second liquid crystal images by decreasing a quantity of bits used to represent a single pixel of each of the at least two layers of second liquid crystal images, and fusing compressed at least two layers of second liquid crystal images to obtain the compressed first liquid crystal image.

In the foregoing design, compression processing is separately performed on all layers of liquid crystal images obtained after layer division such that loss of a large amount of detail information due to overall compression can be reduced, thereby ensuring, to a maximum extent, consistency between a processed displayed image and an original HDR image.

In a possible design, the at least two layers of second liquid crystal images include two layers of second liquid crystal images, and decreasing a quantity of bits used to represent a single pixel of each of the at least two layers of second liquid crystal images is implemented in the manner of separately performing compression processing on pixel values of the two layers of second liquid crystal images based on different compression ratios, and for any pixel whose pixel value is compressed and that is of either of the two layers of second liquid crystal images, using N bits to represent the compressed pixel value of the any pixel whose pixel value is compressed to obtain two layers of compressed second liquid crystal images, where N is a positive integer less than a quantity of bits used to represent the any pixel whose pixel value is compressed.

Further, different compression ratios or a same compression ratio may be configured depending on image feature information included in the at least two layers of second liquid crystal images, and then compression processing is separately performed on pixel values of the at least two layers of second liquid crystal images based on the configured compression ratio.

In the foregoing design, depending on different image feature information included in all layers of liquid crystal images obtained after layer division, different compression ratios are configured for all the layers of liquid crystal images, and then compression processing is performed using different compression degrees such that loss of a large amount of detail information due to overall compression can be reduced, thereby ensuring, to a maximum extent, consistency between a processed displayed image and an original HDR image.

In a possible design, the at least two layers of second liquid crystal images include a low-frequency second liquid crystal image, and the low-frequency second liquid crystal image includes low-frequency image information of the first liquid crystal image, and before decreasing a quantity of bits used to represent a single pixel of each of the at least two layers of second liquid crystal images, the method further includes performing dither processing on the low-frequency second liquid crystal image, performing global tone mapping processing on the low-frequency second liquid crystal image, performing global tone mapping processing on an image obtained after dither processing is performed on the low-frequency second liquid crystal image, or performing dither processing on an image obtained after global tone mapping processing is performed on the low-frequency second liquid crystal image.

Performing dither processing on the low-frequency image can remove artifacts generated in a process of compressing the image. An overall contrast of the image can be adjusted after the global tone mapping processing.

In a possible design, before decreasing a quantity of bits used to represent a single pixel of each of the at least two layers of second liquid crystal images, the method further includes performing dither processing on the at least two layers of second liquid crystal images, performing global tone mapping processing on the at least two layers of second liquid crystal images, separately performing global tone mapping processing on images obtained after dither processing is performed on the at least two layers of second liquid crystal images, or separately performing dither processing on images obtained after global tone mapping processing is performed on the at least two layers of second liquid crystal images.

In a possible design, obtaining a high dynamic range image includes obtaining a to-be-processed image, and using the to-be-processed image as the high dynamic range image when a pixel bit quantity of the to-be-processed image is greater than a preset pixel bit quantity, or performing dequantization processing on the to-be-processed image when a pixel bit quantity of the to-be-processed image is less than or equal to a preset pixel bit quantity, to obtain the high dynamic range image.

Because an existing video transmission channel supports only a video codec of 8 or 10 bits, an HDR image source is compressed into an image of 8 or 10 bits in a video transmission process. How to better restore a high-bit HDR image source from the image of 8 or 10 bits is also a key problem. In this embodiment of the present application, compatibility with an existing image of 8 or 10 bits may be implemented using the foregoing design to obtain the high dynamic range image.

In a possible design, before performing dequantization processing on the to-be-processed image, the method further includes performing global tone mapping processing or degamma processing on the to-be-processed image, to obtain the high dynamic range image.

In a possible design, after performing dequantization processing on the to-be-processed image, the method further includes performing global tone mapping processing or degamma processing on an image obtained after the dequantization processing to obtain the high dynamic range image.

In a possible design, dividing the high dynamic range image into a first liquid crystal image and a first backlight image includes performing backlight statistics collection on the high dynamic range image to obtain the first backlight image, where a backlight value of any region in the high dynamic range image is a pixel value of a pixel that is in the first backlight image and that is corresponding to the region, increasing resolution of the first backlight image, and performing blurring processing on a first backlight image whose resolution is increased, to obtain a second backlight image, where the second backlight image is used to simulate an image displayed after light diffusion processing is performed, using an optical component in the display, on the first backlight image when the first backlight image is displayed at the backlight layer, and obtaining the first liquid crystal image by dividing the high dynamic range image based on the second backlight image.

According to a second aspect, an embodiment of the present application provides a high dynamic range image processing apparatus, including an obtaining unit configured to obtain a high dynamic range image, a division unit configured to divide the high dynamic range image obtained by the obtaining unit into a first liquid crystal image and a first backlight image, a first compression processing unit configured to perform, by decreasing a quantity of bits used to represent a single pixel of the first liquid crystal image obtained by the division unit, compression processing on the first liquid crystal image, to obtain a compressed first liquid crystal image to be displayed at a liquid crystal layer of a display, where the display is configured to display the high dynamic range image, and a second compression processing unit configured to perform, by decreasing a quantity of bits used to represent a single pixel of the first backlight image obtained by the division unit, compression processing on the first backlight image, to obtain a compressed first backlight image to be displayed at a backlight layer of the display.

In a possible design, the first compression processing unit is configured to divide the first liquid crystal image into at least two layers of second liquid crystal images, where the at least two layers of second liquid crystal images include image information of the first liquid crystal image, and any two of the at least two layers of second liquid crystal images include different image information, separately perform compression processing on the at least two layers of second liquid crystal images by decreasing a quantity of bits used to represent a single pixel of each of the at least two layers of second liquid crystal images, and fuse compressed at least two layers of second liquid crystal images to obtain the compressed first liquid crystal image.

In a possible design, the at least two layers of second liquid crystal images include two layers of second liquid crystal images, and when decreasing the quantity of bits used to represent the single pixel of each of the at least two layers of second liquid crystal images, the first compression processing unit is configured to separately perform compression processing on pixel values of the two layers of second liquid crystal images based on different compression ratios, and for any pixel whose pixel value is compressed and that is of either of the two layers of second liquid crystal images, use N bits to represent the compressed pixel value of the any pixel whose pixel value is compressed, to obtain two layers of compressed second liquid crystal images, where N is a positive integer less than a quantity of bits used to represent the any pixel whose pixel value is compressed.

Alternatively, compression processing may be separately performed on pixel values of the two layers of second liquid crystal images using a same compression ratio.

In a possible design, the at least two layers of second liquid crystal images include a low-frequency second liquid crystal image, and the low-frequency second liquid crystal image includes low-frequency image information of the first liquid crystal image, and before decreasing the quantity of bits used to represent the single pixel of each of the at least two layers of second liquid crystal images, the first compression processing unit is further configured to perform dither processing on the low-frequency second liquid crystal image, perform global tone mapping processing on the low-frequency second liquid crystal image, perform global tone mapping processing on an image obtained after dither processing is performed on the low-frequency second liquid crystal image, or perform dither processing on an image obtained after global tone mapping processing is performed on the low-frequency second liquid crystal image.

In a possible design, before decreasing the quantity of bits used to represent the single pixel of each of the at least two layers of second liquid crystal images, the first compression processing unit is further configured to perform dither processing on the at least two layers of second liquid crystal images, perform global tone mapping processing on the at least two layers of second liquid crystal images, separately perform global tone mapping processing on images obtained after dither processing is performed on the at least two layers of second liquid crystal images, or separately perform dither processing on images obtained after global tone mapping processing is performed on the at least two layers of second liquid crystal images.

In a possible design, the obtaining unit is further configured to obtain a to-be-processed image, and the apparatus further includes a bit processing unit configured to use the to-be-processed image as the high dynamic range image when a pixel bit quantity of the to-be-processed image is greater than a pixel bit quantity of a conventional image.

In a possible design, the obtaining unit is further configured to obtain a to-be-processed image, and the apparatus further includes a bit processing unit configured to perform dequantization processing on the to-be-processed image when a pixel bit quantity of the to-be-processed image is less than or equal to a pixel bit quantity of a conventional image, to obtain the high dynamic range image.

In a possible design, before performing dequantization processing on the to-be-processed image, the bit processing unit is further configured to perform global tone mapping processing or degamma processing on the to-be-processed image.

In a possible design, after performing dequantization processing on the to-be-processed image, the bit processing unit is further configured to perform global tone mapping processing or degamma processing on an image obtained after the dequantization processing.

According to a third aspect, an embodiment of the present application further provides a high dynamic range image processing apparatus, and the apparatus includes a receiver configured to obtain a high dynamic range image, a processor configured to divide the high dynamic range image into a first liquid crystal image and a first backlight image, perform compression processing on the first liquid crystal image by decreasing a quantity of bits used to represent a single pixel of the first liquid crystal image, to obtain a compressed first liquid crystal image to be displayed at a liquid crystal layer of a display, where the display is configured to display the high dynamic range image, and perform compression processing on the first backlight image by decreasing a quantity of bits used to represent a single pixel of the first backlight image, to obtain a compressed first backlight image to be displayed at a backlight layer of the display.

In a possible design, the apparatus further includes the display, and the display includes the backlight layer and the liquid crystal layer, where the backlight layer is configured to display the first backlight image, and the liquid crystal layer is configured to display the first liquid crystal image.

Certainly, the display may not be disposed inside the high dynamic range image processing apparatus, and may be an independent device.

In a possible design, the apparatus may further include a memory, where the memory is configured to store a program executed by the processor, and store some configuration information. The configuration information includes an algorithm used for division and the like.

Certainly, the memory may be disposed outside the high dynamic range image processing apparatus, and may be an independent device.

In a possible design, when performing compression processing on the first liquid crystal image by decreasing the quantity of bits used to represent the single pixel of the first liquid crystal image, the processor is further configured to divide the first liquid crystal image into at least two layers of second liquid crystal images, where the at least two layers of second liquid crystal images include image information of the first liquid crystal image, and any two of the at least two layers of second liquid crystal images include different image information, separately perform compression processing on the at least two layers of second liquid crystal images by decreasing a quantity of bits used to represent a single pixel of each of the at least two layers of second liquid crystal images, and fuse compressed at least two layers of second liquid crystal images to obtain the compressed first liquid crystal image.

In a possible design, the at least two layers of second liquid crystal images include two layers of second liquid crystal images, and when decreasing the quantity of bits used to represent the single pixel of each of the at least two layers of second liquid crystal images, the processor is configured to separately perform compression processing on pixel values of the at least two layers of second liquid crystal images based on different compression ratios, and for any pixel whose pixel value is compressed and that is of either of the two layers of second liquid crystal images, use N bits to represent the compressed pixel value of the any pixel whose pixel value is compressed, to obtain two layers of compressed second liquid crystal images, where N is a positive integer less than a quantity of bits used to represent the any pixel whose pixel value is compressed.

In a possible design, the at least two layers of second liquid crystal images include a low-frequency second liquid crystal image, and the low-frequency second liquid crystal image includes low-frequency image information of the first liquid crystal image, and before decreasing the quantity of bits used to represent the single pixel of each of the at least two layers of second liquid crystal images, the processor is further configured to perform dither processing on the low-frequency second liquid crystal image, perform global tone mapping processing on the low-frequency second liquid crystal image, perform global tone mapping processing on an image obtained after dither processing is performed on the low-frequency second liquid crystal image, or perform dither processing on an image obtained after global tone mapping processing is performed on the low-frequency second liquid crystal image.

In a possible design, before decreasing the quantity of bits used to represent the single pixel of each of the at least two layers of second liquid crystal images, the processor is further configured to perform dither processing on the at least two layers of second liquid crystal images, perform global tone mapping processing on the at least two layers of second liquid crystal images, separately perform global tone mapping processing on images obtained after dither processing is performed on the at least two layers of second liquid crystal images, or separately perform dither processing on images obtained after global tone mapping processing is performed on the at least two layers of second liquid crystal images.

In a possible design, the receiver is further configured to obtain a to-be-processed image, and the processor is further configured to use, when a pixel bit quantity of the to-be-processed image obtained by the receiver is greater than a preset pixel bit quantity, the to-be-processed image as the high dynamic range image.

In a possible design, the receiver is further configured to obtain a to-be-processed image, and the processor is further configured to perform, when a pixel bit quantity of the to-be-processed image obtained by the receiver is less than or equal to a preset pixel bit quantity, dequantization processing on the to-be-processed image, to obtain the high dynamic range image.

In a possible design, when dividing the high dynamic range image into the first liquid crystal image and the first backlight image, the processor is configured to perform backlight statistics collection on the high dynamic range image to obtain the first backlight image, where a backlight value of any region in the high dynamic range image is a pixel value of a pixel that is in the first backlight image and that is corresponding to the region, increase resolution of the first backlight image, and perform blurring processing on a first backlight image whose resolution is increased to obtain a second backlight image, where the second backlight image is used to simulate an image displayed after light diffusion processing is performed, using an optical component in the display, on the first backlight image when the first backlight image is displayed at the backlight layer, and obtain the first liquid crystal image by dividing the high dynamic range image based on the second backlight image.

According to a fourth aspect, an embodiment of the present application provides a computer readable storage medium storing one or more programs, the one or more programs include an instruction, and when the instruction is executed by an electronic device, the electronic device performs any method in the first aspect.

In a conventional HDR processing technology, compression processing is first performed on an HDR image and then backlight control processing is performed. In this way, a large quantity of image details of a displayed HDR image are lost. Backlight control processing is performed on a compressed image, and therefore the backlight control processing can only be used to simulate the compressed image in a processing process. This may result in inconsistency between a finally processed displayed image and the original HDR image. In this embodiment of the present application, layer division processing is directly performed on the HDR image, and then backlight control processing is performed on a backlight image obtained after layer division such that loss of a large amount of detail information due to compression can be avoided. Compression processing is performed, using different compression degrees, on all layers of liquid crystal images obtained after layer division such that loss of a large amount of detail information due to overall compression can be reduced, thereby ensuring, to a maximum extent, consistency between a processed displayed image and the original HDR image.

### BRIEF DESCRIPTION OF DRAWINGS

FIG. 1 is a schematic diagram of mapping from high dynamic range light information in the real world to low dynamic range light information of a displayed image on a display according to an embodiment of the present application;

FIG. 2 is a schematic structural diagram of a display according to an embodiment of the present application;

FIG. 3 is a schematic diagram of coding of a 16-bit half-precision floating point type according to an embodiment of the present application;

FIG. 4 is a flowchart of a high dynamic range image processing method according to an embodiment of the present application;

FIG. 5 is a flowchart of a high dynamic range image processing method according to an embodiment of the present application;

FIG. 6A and FIG. 6B are a schematic diagram of a high dynamic range image processing method according to an embodiment of the present application;

FIG. 7 is a schematic diagram of a processing method for dividing a high dynamic range image into three layers according to an embodiment of the present application;

FIG. 8 is a schematic diagram of a high-bit base layer liquid crystal image processing method according to an embodiment of the present application;

FIG. 9 is a schematic diagram of a high-bit detail layer liquid crystal image processing method according to an embodiment of the present application;

FIG. 10A and FIG. 10B are a schematic diagram of a processing method for dividing a high dynamic range image into four layers according to an embodiment of the present application;

FIG. 11 is a schematic diagram of a high dynamic range image processing apparatus according to an embodiment of the present application; and

FIG. 12 is a schematic diagram of another high dynamic range image processing apparatus according to an embodiment of the present application.

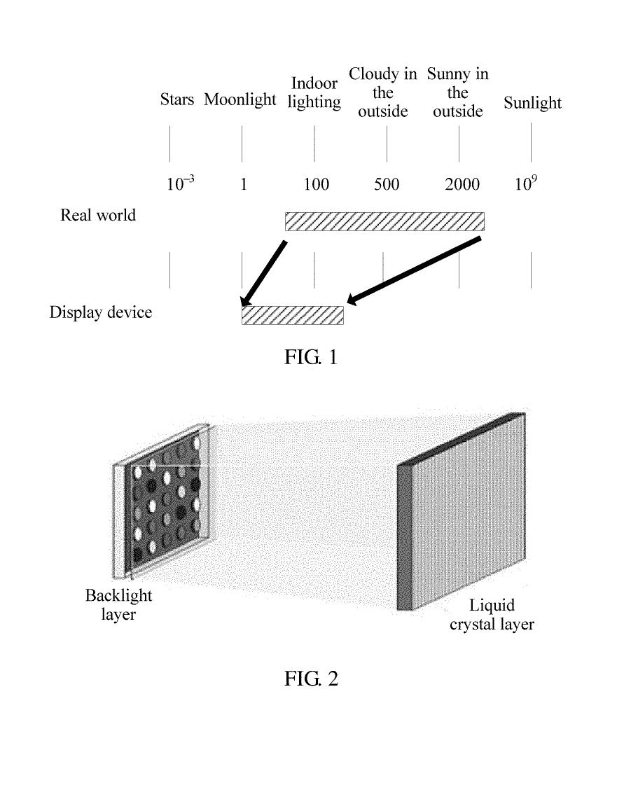

### DESCRIPTION OF EMBODIMENTS

To make the objectives, technical solutions, and advantages of the present application clearer, the following further describes the present application in detail with reference to the accompanying drawings. The described embodiments are merely some rather than all of the embodiments of the present application. All other embodiments obtained by persons of ordinary skill in the art based on the embodiments of the present application without creative efforts shall fall within the protection scope of the present application.

The embodiments of the present application provide a high dynamic range image processing method and apparatus, to resolve a other approaches problem of displayed-image distortion. The method and the apparatus are conceived based on a same application. The method and the apparatus have similar principles for resolving problems. Therefore, for implementation of the apparatus and the method, refer to each other. Details of repeated parts are not described.

A low-resolution image involved in the embodiments of the present application is related to a quantity of backlight partitions. Generally, a consumer level includes no more than 24×10 backlight partitions, and a high-performance laboratory environment includes no more than 256×144 backlight partitions. A high-resolution image is an image whose resolution is slightly different from or the same as that of a common liquid crystal display. For example, the resolution is 720P (1280×720), 1080P (1920×1080), or 4K (4096×2160 or 3840×2160).

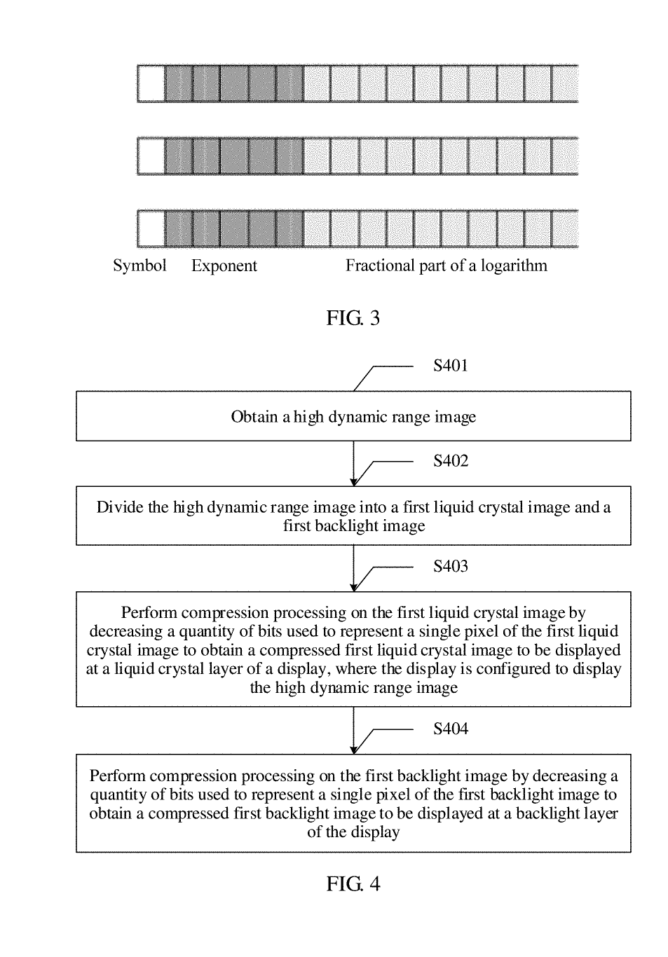

A coding format of a high dynamic range image involved in the embodiments of the present application may be OpenEXR, and a file name extension of OpenEXR is .exr, and is of a 16-bit half-precision floating point type similar to The Institute of Electrical and Electronics Engineers (IEEE) floating point type. Referring to FIG. 3, FIG. 3 is a schematic diagram of coding of the 16-bit half-precision floating point type. The following formula is a formula of converting from a half-precision floating point number used for coding:

$$h = \{ \begin{matrix}{( - 1 )}^{S} {2}^{E - 15} ( 1 + \frac{M}{1024} ) & 1 \leq E \leq 30 \\ {( - 1 )}^{S} {2}^{- 14} ( \frac{M}{1024} ) & E = 30\end{matrix} .$$

S represents a symbol bit, E represents an exponent, and M is a fractional part.

Because OpenEXR can indicate a positive value and a negative value, OpenEXR covers an entire range of visible light, and basically meets an HDR image requirement.

Tone mapping algorithms involved in the embodiments of the present application may be classified into three categories based on a universal classification method a global algorithm, a local algorithm, and a hybrid algorithm. The hybrid algorithm is a combination of the global algorithm and the local algorithm, and has a better effect than the global algorithm and the local algorithm.

Local dimming technologies involved in the embodiments of the present application are classified into 0-D local dimming, 1-D local dimming, and 2-D local dimming. In the 0-D local dimming, backlight luminance is adjusted integrally. In the 1-D local dimming, luminance of different rows may be adjusted. In the 2-D local dimming, partitioning processing may be performed based on backlight situations, to dynamically adjust backlight luminance of different partitions, thereby reducing power consumption of a display while increasing a dynamic range of a displayed image. Currently, the 2-D local dimming is the most widely used backlight control method with the best effect.

A bit quantity of a low-bit image involved in the embodiments of the present application is equal to a bit quantity of a conventional image, and is usually 8 or 10 bits. A high-bit image is an HDR image, and is usually 16-bit half-precision floating point data or 32-bit floating point data.

The embodiments of the present application are applicable to a display that can implement a local dimming technology, for example, an LED backlight display, and the display is usually a double-layer structure, and includes a backlight layer and a liquid crystal layer.

The backlight layer generally displays low-frequency information of an image, and has relatively low resolution. Specific resolution is determined by a quantity of backlight partitions. The liquid crystal layer displays remaining information of the image after backlight information is removed, and has relatively high resolution, and the resolution is usually 720P, 1080P, or 4K.

An embodiment of the present application provides a high dynamic range image processing method. Referring to FIG. 4, the method includes the following steps.

Step S401: Obtain a high dynamic range image.

Resolution of the high dynamic range image is the same as resolution of a liquid crystal layer of a display configured to display the high dynamic range image.

Step S402: Divide the high dynamic range image into a first liquid crystal image and a first backlight image.

Optionally, dividing the high dynamic range image into a first liquid crystal image and a first backlight image may be implemented in the manner of performing backlight statistics collection on the high dynamic range image to obtain the first backlight image, where a backlight value of any region in the high dynamic range image is a pixel value of a pixel that is in the first backlight image and that is corresponding to the region, increasing resolution of the first backlight image, and performing blurring processing on a first backlight image whose resolution is increased to obtain a second backlight image, where the second backlight image is used to simulate an image displayed after light diffusion processing is performed, using an optical component in the display, on the first backlight image when the first backlight image is displayed at a backlight layer, and obtaining the first liquid crystal image by dividing the high dynamic range image based on the second backlight image.

The resolution of the first backlight image is slightly different from or the same as resolution of the backlight layer of the display configured to display the high dynamic range image. The first backlight image is a low-resolution image.

Performing backlight statistics collection on the high dynamic range image includes collecting statistics about backlight luminance values of different partitions of the high dynamic range image. In other words, one partition corresponds to one backlight luminance value in order to obtain an image including the backlight luminance values, and the image is referred to as the first backlight image. It may be considered that the first backlight image includes only the backlight luminance values, and the first backlight image is a low-resolution image whose resolution is the same as a quantity of backlight partitions.

There are a plurality of methods for collecting statistics about the backlight luminance values of the different partitions of the high dynamic range image, and the methods may include but are not limited to the following methods an average value method, a square root method, a maximum value method, and a mapping function inversion method. The methods for collecting statistics about the backlight luminance values of the different partitions of the high dynamic range image are not limited in this embodiment of the present application. Another other approaches method for collecting statistics about backlight luminance values of different partitions of an image is also applicable to this embodiment of the present application.

The following briefly describes various methods for collecting statistics about the backlight luminance values of the different partitions of the high dynamic range image.

In the average value method, an average value of backlight luminance values of all pixels included in a region is further used as a backlight luminance value of the region.

In the square root method, a square root value of an average value of backlight luminance values of all pixels included in a region is further used as a backlight luminance value of the region.

In the maximum value method, a maximum value of backlight luminance values of all pixels included in a region is further used as a backlight luminance value of the region.

In the mapping function inversion method, a histogram of an entire image is obtained through statistics collection, a cumulative distribution function of the histogram is obtained, and then an inverse function of the cumulative distribution function is used as an inverse function of a mapping function. Statistics about an average value of backlight luminance values of all pixels included in each region are collected, and then the obtained average value of each region is input into the inverse function of the mapping function, to obtain a backlight luminance value of each region. Different image frames have different cumulative distribution function curves, and an optimal backlight luminance value may be obtained based on different features of all frames of input images.

The second backlight image is a high-resolution image, and resolution of the second backlight image may be, for example, 720P, 1080P, or 4K.

The obtained second backlight image is a simulated high-resolution liquid crystal image, and specific resolution may be 720P, 1080P, 4K, or the like.

Light diffusion processing, performed by the optical component on the first backlight image when the first backlight image is displayed, may be simulated using a light diffusion function, to obtain the second backlight image. The light diffusion function describes light transmission performance that light emitted from an LED is incident to a liquid crystal display after being diffused by a diffusion film (board) for a plurality of times. Light luminance of each pixel that is incident to the liquid crystal display can be accurately learned using the light diffusion function in order to accurately compensate for a liquid crystal pixel.

There are a plurality of light diffusion functions used for simulating light diffusion. In this embodiment of the present application, an interpolation method and a blur-mask method are used as an example for description. However, another other approaches method for a light diffusion function used for simulating light diffusion also falls within the protection scope of the embodiments of the present application, and details are not described herein in this embodiment of the present application.

The interpolation method can be used to perform interpolation on a low-resolution image to obtain a high-resolution image.

In the blur-mask method, a low-resolution image is first extended. Further, a pixel quantity of the image is doubled horizontally and vertically, blurring processing is performed using a low-pass filter, and the foregoing steps are repeated, to obtain a high-resolution image whose resolution is the same as the resolution of the liquid crystal layer of the display. An iteration process is involved herein, and a table lookup manner of displaying a look-up table (LUT) may be used to replace the foregoing iteration process. The LUT stores a mapping relationship between a low-resolution image and a final high-resolution image, and is more convenient for hardware implementation.

Obtaining the first liquid crystal image by dividing the high dynamic range image based on the second backlight image may be implemented in the manner of obtaining the first liquid crystal image after performing a subtraction operation on a pixel luminance value of the high dynamic range image and a pixel luminance value corresponding to the second backlight image, or obtaining the first liquid crystal image after performing a division operation on a pixel luminance value of the high dynamic range image and a pixel luminance value corresponding to the second backlight image.

Step S403: Perform compression processing on the first liquid crystal image by decreasing a quantity of bits used to represent a single pixel of the first liquid crystal image to obtain a compressed first liquid crystal image to be displayed at a liquid crystal layer of a display, where the display is configured to display the high dynamic range image.

Step S404: Perform compression processing on the first backlight image by decreasing a quantity of bits used to represent a single pixel of the first backlight image to obtain a compressed first backlight image to be displayed at a backlight layer of the display.

A sequence of performing step S403 and step S404 is not limited in this embodiment of the present application.

Optionally, in this embodiment of the present application, the obtained first backlight image may further be processed, and resolution of the first backlight image is processed. This may be implemented in the manner of performing light diffusion processing on the first backlight image using an optical component to obtain a high-resolution third backlight image, where the third backlight image is used to overlap the compressed first liquid crystal image for displaying.

According to the solution provided in this embodiment of the present application, layer division processing is performed on an HDR image (for example, 16 bits) to obtain a backlight layer image and a liquid crystal layer image, then dimming is performed on the backlight layer image, the liquid crystal layer image is compensated for, and the two layers of images are overlaid to obtain a final image that can be displayed by a display. Therefore, an obtained image used for a local dimming module is a to-be-compressed high-bit image, a large quantity of image details are reserved, and a finally displayed image effect is used to simulate the high-bit image. This ensures, to a maximum extent, that an HDR image displayed after processing is consistent with an original HDR image source, and image distortion is reduced.

Optionally, performing compression processing on the first liquid crystal image by decreasing a quantity of bits used to represent a single pixel of the first liquid crystal image may be implemented in the manner of dividing the first liquid crystal image into at least two layers of second liquid crystal images, where the at least two layers of second liquid crystal images include image information of the first liquid crystal image, and any two of the at least two layers of second liquid crystal images include different image information, separately performing compression processing on the at least two layers of second liquid crystal images by decreasing a quantity of bits used to represent a single pixel of each of the at least two layers of second liquid crystal images, and fusing compressed at least two layers of second liquid crystal images to obtain the compressed first liquid crystal image.

Further, the first liquid crystal image may be divided into the at least two layers of second liquid crystal images using at least one local tone mapping algorithm.

There are a plurality of local tone mapping algorithms used for layer division, for example, bilateral filtering and guided filtering.

The bilateral filtering means that an image intensity value is introduced as an input parameter of a bilateral filter on the basis of Gaussian filtering and both an image spatial location and image intensity information are considered such that the bilateral filtering can improve compatibility between the image spatial location and an image pixel intensity value, and has a function of well reserving an image edge. Layer division processing is performed on the image without generating obvious artifacts, and the image is divided into at least two layers.

The artifacts include contouring, a halo, banding, and the like.

The bilateral filtering is used as an example in the foregoing solution for description, but the foregoing solution is not limited to this method, and another local tone mapping method also falls within the protection scope of this patent.

Optionally, the at least two layers of second liquid crystal images include two layers of second liquid crystal images, and decreasing a quantity of bits used to represent a single pixel of each of the at least two layers of second liquid crystal images includes separately performing compression processing on pixel values of the two layers of second liquid crystal images based on different compression ratios, and for any pixel whose pixel value is compressed and that is of either of the two layers of second liquid crystal images, using N bits to represent the compressed pixel value of the any pixel whose pixel value is compressed to obtain two layers of compressed second liquid crystal images, where N is a positive integer less than a quantity of bits used to represent the any pixel whose pixel value is compressed.

A pixel value change in a compression process may be implemented through table lookup.

Further, the compression ratios are preconfigured depending on image feature information included in the at least two layers of second liquid crystal images. More image detail features included in the second liquid crystal image indicate a smaller compression degree.

For example, two layers of second liquid crystal images are obtained after processing. One layer of second liquid crystal image includes basic feature information included in the first liquid crystal image, for example, some low-frequency information. For ease of description, the one layer of second liquid crystal image is referred to as a base layer image. The other layer of second liquid crystal image includes detail feature information included in the first liquid crystal image, for example, high-frequency information. For ease of description, the other layer of second liquid crystal image is referred to as a detail layer image. Because a detail layer liquid crystal image includes a relatively large quantity of image detail features, a compression degree is less than a compression degree of a base layer liquid crystal image.

Optionally, the fusing compressed at least two layers of second liquid crystal images to obtain the compressed first liquid crystal image may be implemented in the following manner.

Fusing processing may first be performed on the compressed at least two layers of second liquid crystal images, and then conventional post processing is performed to obtain the compressed first liquid crystal image.

Conventional post processing methods include sharpness, dynamic contrast improvement (DCI), and the like.

Optionally, the at least two layers of second liquid crystal images include a low-frequency second liquid crystal image, and the low-frequency second liquid crystal image includes low-frequency image information of the first liquid crystal image. Before the quantity of bits used to represent the single pixel of each of the at least two layers of second liquid crystal images is decreased, the following processing may be further performed on the low-frequency second liquid crystal image: performing dither processing on the low-frequency second liquid crystal image, performing global tone mapping processing on the low-frequency second liquid crystal image, performing global tone mapping processing on an image obtained after dither processing is performed on the low-frequency second liquid crystal image, or performing dither processing on an image obtained after global tone mapping processing is performed on the low-frequency second liquid crystal image.

For ease of description, the low-frequency second liquid crystal image is referred to as a base layer image in this embodiment of the present application.

Performing dither processing on the base layer image can remove artifacts generated in a process of compressing the image.

An overall contrast of the image can be adjusted after the global tone mapping processing.

Optionally, before decreasing a quantity of bits used to represent a single pixel of each of the at least two layers of second liquid crystal images, the method further includes performing dither processing on the at least two layers of second liquid crystal images, performing global tone mapping processing on the at least two layers of second liquid crystal images, separately performing global tone mapping processing on images obtained after dither processing is performed on the at least two layers of second liquid crystal images, or separately performing dither processing on images obtained after global tone mapping processing is performed on the at least two layers of second liquid crystal images.

Because an existing video transmission channel supports only a video codec of 8 or 10 bits, an HDR image source is compressed into an image of 8 or 10 bits in a video transmission process. How to better restore a high-bit HDR image source from the image of 8 or 10 bits is also a key problem. In this embodiment of the present application, compatibility with an existing image of 8 or 10 bits may be implemented using the following algorithm to obtain the high dynamic range image obtaining a to-be-processed image, and using the to-be-processed image as the high dynamic range image when a pixel bit quantity of the to-be-processed image is greater than a pixel bit quantity of a conventional image, or performing dequantization processing on the to-be-processed image when a pixel bit quantity of the to-be-processed image is less than or equal to a pixel bit quantity of a conventional image to obtain the high dynamic range image.

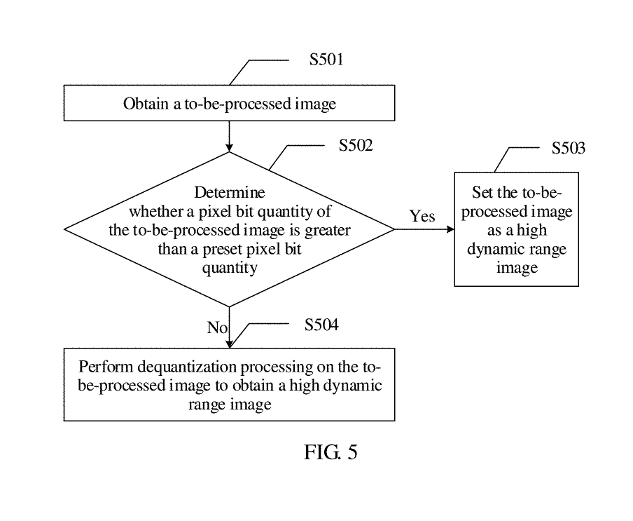

Further, as shown in FIG. 5, the following steps are included.

Step S501. Obtain a to-be-processed image.

Step S502. Determine whether a pixel bit quantity of the to-be-processed image is greater than a preset pixel bit quantity, and if the pixel bit quantity of the to-be-processed image is greater than the preset pixel bit quantity, step S503 is performed, or if the pixel bit quantity of the to-be-processed image is not greater than the preset pixel bit quantity, step S504 is performed. The preset pixel bit quantity is the same as a bit quantity of a conventional image, and may be 10 bits.

Step S503. Set the to-be-processed image as a high dynamic range image.

Step S504. Perform dequantization processing on the to-be-processed image to obtain a high dynamic range image.

A dequantization method may include but is not limited to a flooding algorithm, a dither algorithm, a filtering method, and the like. Another dequantization method in the other approaches is also applicable to this embodiment of the present application, and details are not described herein in this embodiment of the present application.

Flooding means to determine a flooding direction based on image content information, and then perform dequantization based on a minimization cost function. Dither means to perform dequantization by randomly adding disturbance. Filtering means to perform dequantization by simulating flooding using a filter. An HDR image can be well restored using the foregoing dequantization algorithms.

Optionally, in step S504, when the high dynamic range image is obtained, global tone mapping processing or degamma processing may further be performed on the to-be-processed image.

Further, global tone mapping processing or degamma processing may be performed on the to-be-processed image before dequantization processing is performed on the to-be-processed image, or after dequantization processing is performed on the to-be-processed image, global tone mapping processing or degamma processing may be performed on an image obtained after the dequantization processing.

In a conventional HDR processing technology, compression processing is first performed on an HDR image and then backlight control processing is performed. In this way, a large quantity of image details of a displayed HDR image is lost. Backlight control processing is performed on a compressed image, and therefore the backlight control processing can only be used to simulate the compressed image in a processing process. This may result in inconsistency between a finally processed displayed image and the original HDR image. In this embodiment of the present application, layer division processing is directly performed on the HDR image, and then backlight control processing is performed on a backlight image obtained after layer division such that loss of a large amount of detail information due to compression can be avoided. Compression processing is performed, using different compression degrees, on all layers of liquid crystal images obtained after layer division such that loss of a large amount of detail information due to overall compression can be reduced, thereby ensuring, to a maximum extent, consistency between a processed displayed image and the original HDR image.

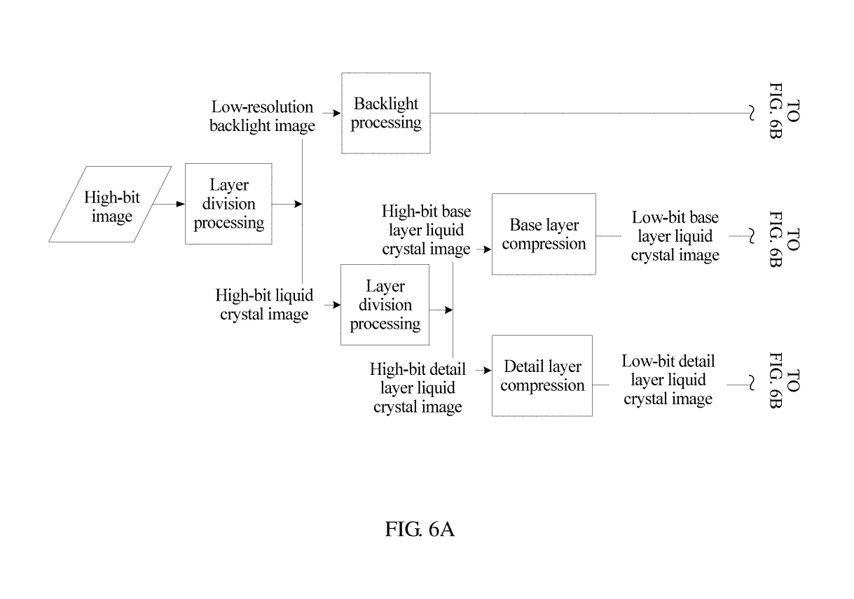

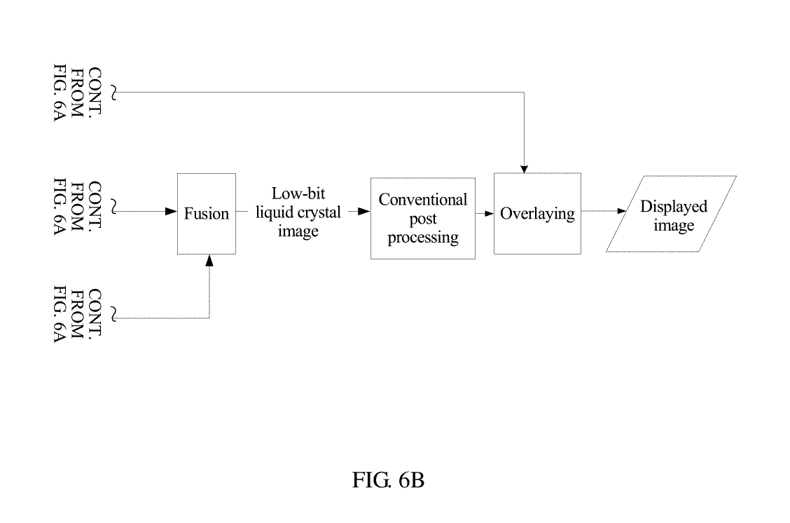

As shown in FIG. 6A and FIG. 6B, for example, an HDR image is divided into three layers below for description.

It is assumed that the HDR image is to be processed, and the HDR image needs to be processed and then displayed. A processing procedure is as follows.

A1: Obtain the HDR image. A common HDR image is a high-bit image. For ease of description, the HDR image is referred to as a high-bit image.

A2: Perform layer division processing on the HDR image to obtain a first backlight image and a first liquid crystal image.

The first backlight image includes only a backlight luminance value of each partition obtained after backlight partitioning, and therefore is a low-resolution image. Herein, for ease of description, the first backlight image is referred to as a low-resolution backlight image. Resolution of the low-resolution backlight image is slightly different from or the same as resolution of a backlight layer of a display. A bit quantity of the obtained first liquid crystal image is greater than a bit quantity of a conventional image. Therefore, for ease of description, the first liquid crystal image is referred to as a high-bit liquid crystal image in this embodiment of the present application. Resolution of the high-bit liquid crystal image is slightly different from resolution of a liquid crystal layer image of the display, and is usually 720P, 1080P, 4K, or the like. In this embodiment of the present application, that resolution of a high-resolution image is the same as the resolution of the liquid crystal layer image of the display is used as an example.

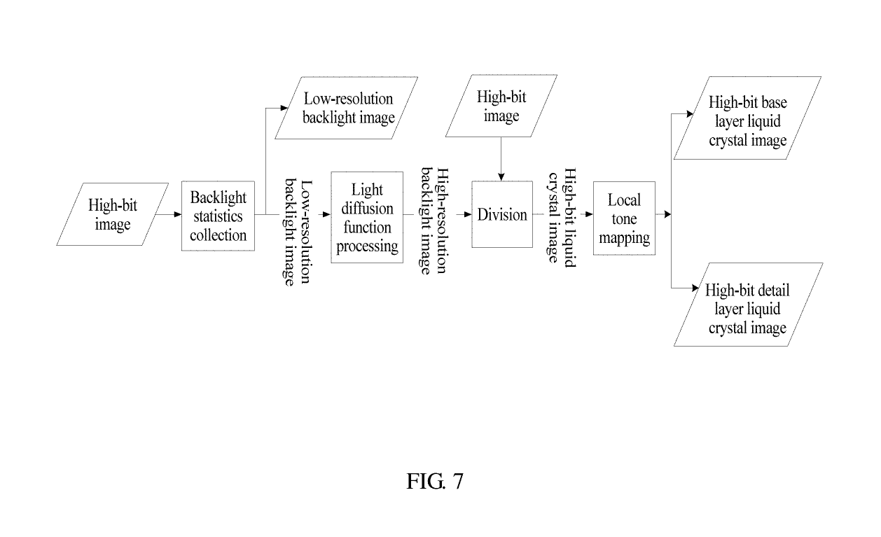

Further, referring to FIG. 7, performing layer division processing on the HDR image to obtain a low-resolution backlight image and a high-bit liquid crystal image may be implemented in the following manner.

B1: Perform backlight statistics collection on the HDR image to obtain the low-resolution backlight image.

For a backlight statistics collection manner, refer to the manner described in the embodiment corresponding to FIG. 2. Details are not described again in this embodiment of the present application.

B2: Process the low-resolution backlight image using a light diffusion function used for simulating light diffusion to obtain a simulated high-resolution backlight image whose resolution is the same as that of a liquid crystal display on which the HDR image is to be displayed. The resolution of the high-resolution backlight image is usually 720P, 1080P, 4K, or the like.

B3: Obtain the high-bit liquid crystal image by dividing the high-bit image based on the high-resolution backlight image.

The high-bit liquid crystal image is obtained after a subtraction operation is performed on a pixel luminance value of the high-bit image and a pixel luminance value corresponding to the high-resolution backlight image, or the high-bit liquid crystal image is obtained after a division operation is performed on a pixel luminance value of the high-bit image and a pixel luminance value corresponding to the high-resolution backlight image. The resolution of the high-bit liquid crystal image is the same as resolution of a liquid crystal layer.

A3: Perform layer division processing on the high-bit liquid crystal image to obtain two layers of second liquid crystal images.

One of the two layers of second liquid crystal images includes basic feature information such as low-frequency information of the first liquid crystal image. In addition, a pixel bit quantity of the second liquid crystal image is greater than a pixel bit quantity (8 or 10 bits) of a conventional image such that this layer of second liquid crystal image is referred to as a high-bit base layer liquid crystal image. The other layer of second liquid crystal image includes detail feature information such as high-frequency information of the first liquid crystal image, and the other layer of second liquid crystal image is referred to as a high-bit detail layer liquid crystal image.

Further, layer division processing is performed on the high-bit liquid crystal image using a local tone mapping algorithm to obtain the high-bit base layer liquid crystal image and the high-bit detail layer liquid crystal image.

A4 Separately process and then overlay the low-resolution backlight image, the high-bit base layer liquid crystal image, and the high-bit detail layer liquid crystal image to obtain a displayed image.

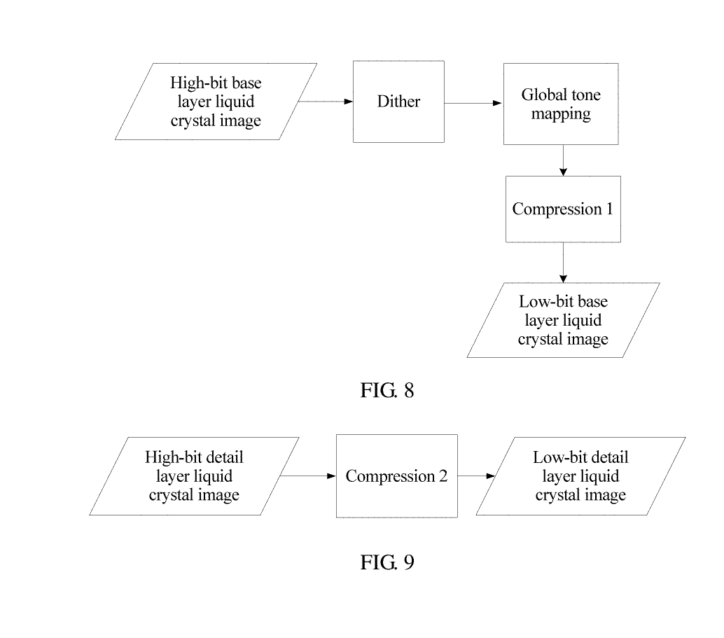

Further, light diffusion processing is performed on the low-resolution backlight image using an optical component to obtain a displayed high-resolution backlight image. Resolution of the high-resolution backlight image is the same as the resolution of the liquid crystal layer of the display. For a backlight processing manner, refer to the manner described in the embodiment corresponding to FIG. 4. Details are not described again in this embodiment of the present application. Base layer compression processing is performed on the high-bit base layer liquid crystal image to obtain a low-bit base layer liquid crystal image. For example, as shown in FIG. 8, global tone mapping processing is performed on a high-bit base layer liquid crystal image, dither processing is performed on an image obtained after the global tone mapping processing, and then compression processing 1 is performed to obtain a low-bit base layer image.

Detail layer compression processing is performed on the high-bit detail layer liquid crystal image to obtain a low-bit detail layer liquid crystal image. For example, as shown in FIG. 9, compression processing 2 is performed on a high-bit detail layer liquid crystal image to obtain a low-bit detail layer image. A compression ratio configured for the compression 1 is greater than a compression ratio configured for the compression 2. Certainly, dither processing and global tone mapping processing may further be performed before compression processing 2 is performed on the high-bit detail layer liquid crystal image. Then, the displayed high-resolution backlight image, low-bit base layer liquid crystal image, and low-bit detail layer liquid crystal image are overlaid to obtain the displayed image.

Alternatively, the low-bit base layer liquid crystal image and the low-bit detail layer liquid crystal image may be first fused, then conventional post processing is performed, and then a low-bit image obtained after the post processing and the high-resolution backlight image are overlaid to obtain the displayed image.

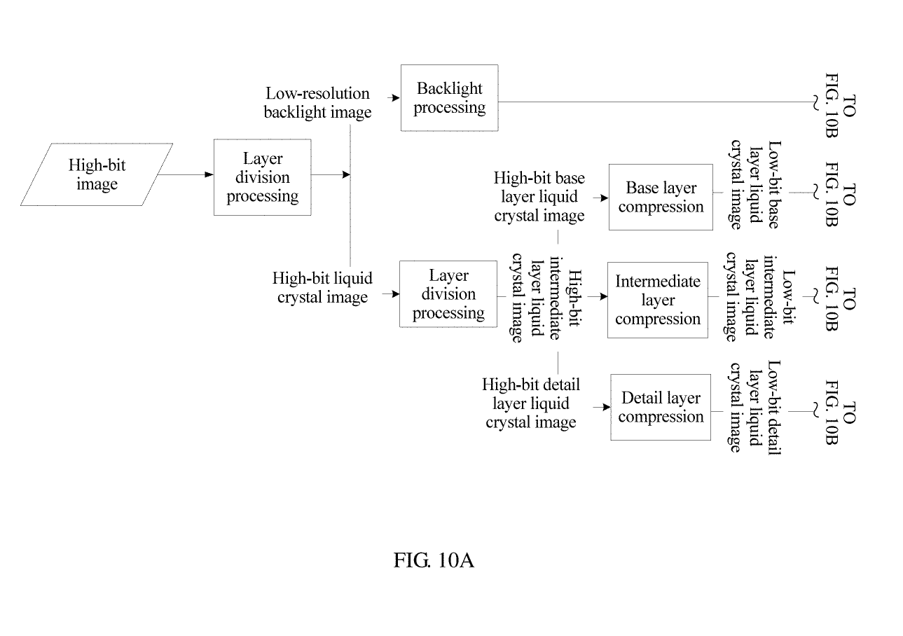

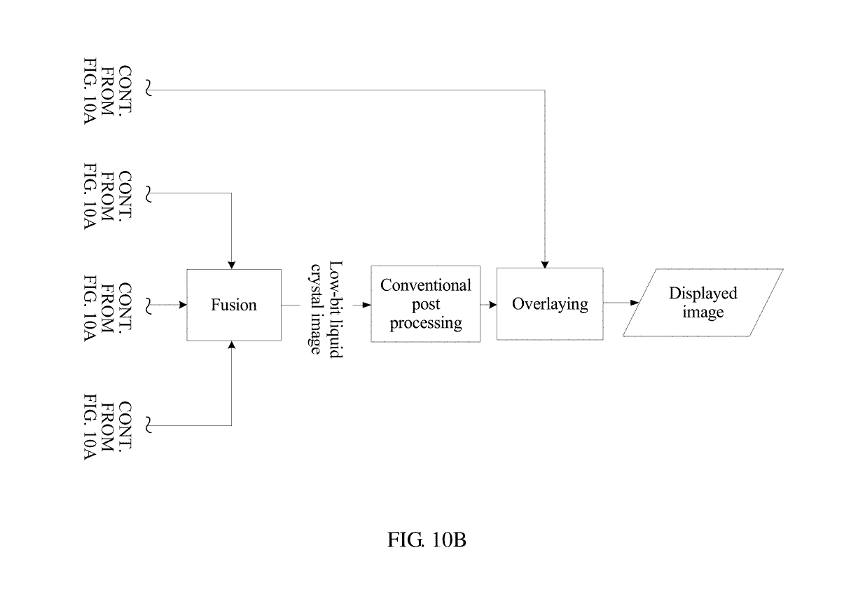

Certainly, in this embodiment of the present application, the HDR image is not limited to being divided into three layers, and may also be divided into four or more layers. For example, as shown in FIG. 10A and FIG. 10B, an HDR image is divided into four layers, including a low-resolution backlight image, a high-bit base layer liquid crystal image, a high-bit intermediate layer liquid crystal image, and a high-bit detail layer liquid crystal image. The high-bit base layer liquid crystal image, the high-bit intermediate layer liquid crystal image, and the high-bit detail layer liquid crystal image include different feature information of a liquid crystal image.

During layer division processing, the HDR image may be divided into the low-resolution backlight image and a high-bit liquid crystal image. Then, the high-bit liquid crystal image may further be divided into the high-bit base layer liquid crystal image, the high-bit intermediate layer liquid crystal image, and the high-bit detail layer liquid crystal image using a local tone mapping algorithm. Alternatively, the high-bit liquid crystal image may further be divided into the high-bit base layer liquid crystal image and the first high-bit detail layer liquid crystal image using one local tone mapping algorithm, and then the first high-bit detail layer liquid crystal image is further divided into the high-bit intermediate layer liquid crystal image and a second high-bit detail layer liquid crystal image using another local tone mapping algorithm. A quantity of used local tone mapping algorithms is not limited in this embodiment of the present application. Certainly, the high-bit liquid crystal image may be divided into a plurality of layers of images using a plurality of local tone mapping algorithms, and then compression processing is separately performed on the plurality of layers of images. Different compression ratios are used when compression processing is performed on the plurality of layers of images, and the different compression ratios may be further configured depending on included feature information.

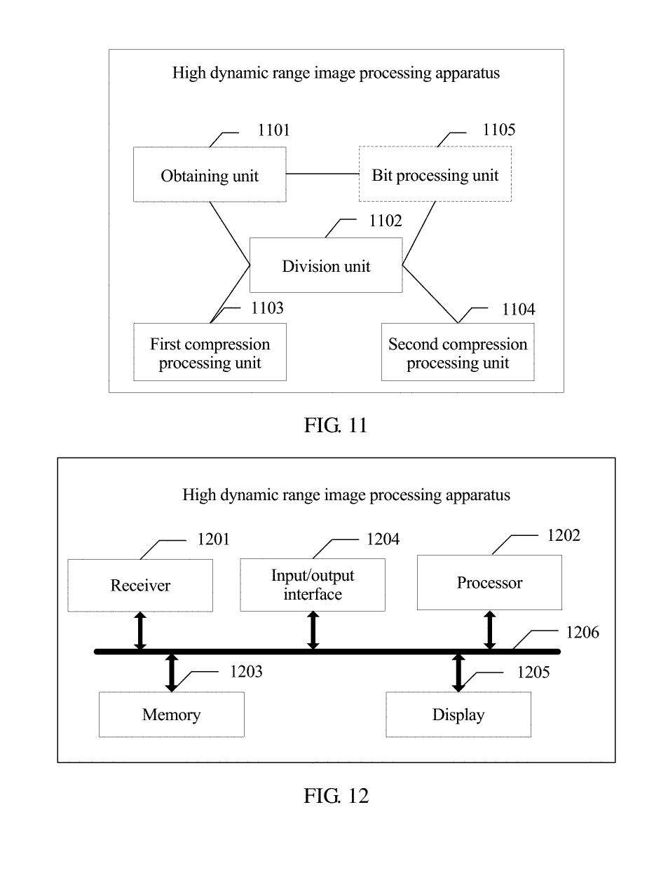

Based on a same inventive concept as the foregoing method embodiment, an embodiment of the present application provides a high dynamic range image processing apparatus. As shown in FIG. 11, the apparatus includes an obtaining unit 1101 configured to obtain a high dynamic range image, a division unit 1102 configured to divide the high dynamic range image obtained by the obtaining unit into a first liquid crystal image and a first backlight image, a first compression processing unit 1103 configured to perform, by decreasing a quantity of bits used to represent a single pixel of the first liquid crystal image obtained by the division unit 1102, compression processing on the first liquid crystal image, to obtain a compressed first liquid crystal image to be displayed at a liquid crystal layer of a display, where the display is configured to display the high dynamic range image, and a second compression processing unit 1104 configured to perform, by decreasing a quantity of bits used to represent a single pixel of the first backlight image obtained by the division unit 1102, compression processing on the first backlight image to obtain a compressed first backlight image to be displayed at a backlight layer of the display.

Optionally, the first compression processing unit 1103 is configured to divide the first liquid crystal image into at least two layers of second liquid crystal images, where the at least two layers of second liquid crystal images include image information of the first liquid crystal image, and any two of the at least two layers of second liquid crystal images include different image information, separately perform compression processing on the at least two layers of second liquid crystal images by decreasing a quantity of bits used to represent a single pixel of each of the at least two layers of second liquid crystal images, and fuse compressed at least two layers of second liquid crystal images to obtain the compressed first liquid crystal image.

Optionally, the at least two layers of second liquid crystal images include two layers of second liquid crystal images, and when decreasing the quantity of bits used to represent the single pixel of each of the at least two layers of second liquid crystal images, the first compression processing unit 1103 is configured to separately perform compression processing on pixel values of the two layers of second liquid crystal images based on different compression ratios, and for any pixel whose pixel value is compressed and that is of either of the two layers of second liquid crystal images, use N bits to represent the compressed pixel value of the any pixel whose pixel value is compressed to obtain two layers of compressed second liquid crystal images, where N is a positive integer less than a quantity of bits used to represent the any pixel whose pixel value is compressed.

Alternatively, compression processing may be separately performed on pixel values of the two layers of second liquid crystal images using a same compression ratio. This is not further limited in this embodiment of the present application.

Optionally, the at least two layers of second liquid crystal images include a low-frequency second liquid crystal image, and the low-frequency second liquid crystal image includes low-frequency image information of the first liquid crystal image, and before decreasing the quantity of bits used to represent the single pixel of each of the at least two layers of second liquid crystal images, the first compression processing unit 1103 is further configured to perform dither processing on the low-frequency second liquid crystal image, perform global tone mapping processing on the low-frequency second liquid crystal image, perform global tone mapping processing on an image obtained after dither processing is performed on the low-frequency second liquid crystal image, or perform dither processing on an image obtained after global tone mapping processing is performed on the low-frequency second liquid crystal image.

Before decreasing the quantity of bits used to represent the single pixel of each of the at least two layers of second liquid crystal images, the first compression processing unit 1103 is further configured to perform dither processing on the at least two layers of second liquid crystal images, perform global tone mapping processing on the at least two layers of second liquid crystal images, separately perform global tone mapping processing on images obtained after dither processing is performed on the at least two layers of second liquid crystal images, or separately perform dither processing on images obtained after global tone mapping processing is performed on the at least two layers of second liquid crystal images.

Because an existing video transmission channel supports only a video codec of 8 or 10 bits, an HDR image source is compressed into an image of 8 or 10 bits in a video transmission process. How to better restore a high-bit HDR image source from the image of 8 or 10 bits is also a key problem. In this embodiment of the present application, compatibility with an existing image of 8 or 10 bits may be implemented using the following algorithm, to obtain the high dynamic range image.

Optionally, the obtaining unit 1101 is further configured to obtain a to-be-processed image.

The apparatus further includes a bit processing unit 1105 configured to use the to-be-processed image as the high dynamic range image when a pixel bit quantity of the to-be-processed image is greater than a preset pixel bit quantity.

Optionally, the bit processing unit 1105 is further configured to perform dequantization processing on the to-be-processed image when a pixel bit quantity of the to-be-processed image is less than or equal to a preset pixel bit quantity to obtain the high dynamic range image.

Optionally, before performing dequantization processing on the to-be-processed image, the bit processing unit 1105 is further configured to perform global tone mapping processing or degamma processing on the to-be-processed image.

Optionally, after performing dequantization processing on the to-be-processed image, the bit processing unit 1105 is further configured to perform global tone mapping processing or degamma processing on an image obtained after the dequantization processing.

The high dynamic range image can be better restored after the global tone mapping processing or the degamma processing.

Unit division in this embodiment of the present application is an example, is only logical function division, and may be another division manner in actual implementation. In addition, functional units in the embodiments of this application may be integrated into one processor, or may exist alone physically, or two or more units may be integrated into one unit. The integrated unit may be implemented in a form of hardware, or may be implemented in a form of a software functional module.

When the integrated unit may be implemented in a form of hardware, as shown in FIG. 12, the high dynamic range image processing apparatus includes a receiver 1201 and a processor 1202. The processor 1202 may be a central processing unit (CPU), a digital processing unit, or the like. The high dynamic range image processing apparatus further includes a memory 1203 configured to store a program executed by the processor 1202, and the processor 1202 is configured to execute the program stored in the memory 1203. The memory 1203 is further configured to store some configuration information for an image, for example, algorithm information used for processing the image and a compression ratio used for compressing the image.

The memory 1203 may be disposed inside the high dynamic range image processing apparatus, or may be disposed outside the high dynamic range image processing apparatus. The high dynamic range image processing apparatus may further include an input/output interface 1204 configured to write the program and the configuration information into the memory 1203 and output a processed image.

The high dynamic range image processing apparatus may further include a display 1205, for example, an LED display. Certainly, the display 1205 may be disposed inside the high dynamic range image processing apparatus, or may be disposed outside the high dynamic range image processing apparatus as an independent device.

The receiver 1201, the memory 1203, the processor 1202, the input/output interface 1204, and the display 1205 may be connected using a bus 1206. A manner of connection between other components is merely a schematic description rather than a limitation. The bus 1206 may be classified into an address bus, a data bus, a control bus, and the like. For ease of representation, only one bold line is used in FIG. 12 for representation, but it does not indicate that there is only one bus or one type of bus.

The memory 1203 may be a volatile memory such as a random-access memory (RAM). Alternatively, the memory 1203 may be a non-volatile memory such as a read-only memory (ROM), a flash memory, a hard disk drive (HDD), or a solid-state drive (SSD). Alternatively, the memory 1203 is any other medium that can be used to carry or store expected program code in a command or data structure form and that can be accessed by a computer. However, this is not limited thereto. The memory 1203 may be a combination of the memories.

The display 1205 may be divided into a backlight layer and a liquid crystal layer.

The receiver 1201 is configured to obtain a to-be-processed image. The image may be a high range dynamic image such that the processor 1202 processes the to-be-processed image.

The processor 1202 is configured to execute the program stored in the memory 1203, and is configured to perform the methods corresponding to the embodiments shown in FIG. 4 and FIG. 5. For content of execution, refer to the embodiments shown in FIG. 4 and FIG. 5. Brief description is provided herein in this embodiment of the present application, and details are not repeated.

The processor 1202 is configured to divide the high dynamic range image obtained by the receiver 1201 into a first liquid crystal image and a first backlight image, perform compression processing on the first liquid crystal image by decreasing a quantity of bits used to represent a single pixel of the first liquid crystal image, to obtain a compressed first liquid crystal image to be displayed at a liquid crystal layer of the display 1205, where the display 1205 is configured to display the high dynamic range image, and perform compression processing on the first backlight image by decreasing a quantity of bits used to represent a single pixel of the first backlight image to obtain a compressed first backlight image to be displayed at a backlight layer of the display.

The high dynamic range image processing apparatus provided in this embodiment of the present application may be applied to a video codec.

In a conventional HDR processing technology, compression processing is first performed on an HDR image and then backlight control processing is performed. In this way, a large quantity of image details of a displayed HDR image is lost. Backlight control processing is performed on a compressed image, and therefore the backlight control processing can only be used to simulate the compressed image in a processing process. This may result in inconsistency between a finally processed displayed image and the original HDR image. In this embodiment of the present application, layer division processing is directly performed on the HDR image, and then backlight control processing is performed on a backlight image obtained after layer division such that loss of a large amount of detail information due to compression can be avoided. Compression processing is performed, using different compression degrees, on all layers of liquid crystal images obtained after layer division such that loss of a large amount of detail information due to overall compression can be reduced, thereby ensuring, to a maximum extent, consistency between a processed displayed image and the original HDR image.

Persons skilled in the art should understand that the embodiments of the present application may be provided as a method, a system, or a computer program product. Therefore, the present application may use a form of hardware only embodiments, software only embodiments, or embodiments with a combination of software and hardware. Moreover, the present application may use a form of a computer program product that is implemented on one or more computer-usable storage media (including but being not limited to a disk memory, a compact disc ROM (CD-ROM), an optical memory, and the like) that include computer-usable program code.

The present application is described with reference to the flowcharts and/or block diagrams of the method, the device (system), and the computer program product according to the embodiments of the present application. It should be understood that computer program instructions may be used to implement each process and/or each block in the flowcharts and/or the block diagrams, and a combination of a process and/or a block in the flowcharts and/or the block diagrams. These computer program instructions may be provided for a general-purpose computer, a special-purpose computer, an embedded processor, or a processor of any other programmable data processing device to generate a machine such that the instructions executed by a computer or a processor of any other programmable data processing device generate an apparatus for implementing a specified function in one or more processes in the flowcharts and/or in one or more blocks in the block diagrams.

These computer program instructions may also be stored in a computer readable memory that can instruct the computer or any other programmable data processing device to work in a specified manner such that the instructions stored in the computer readable memory generate an artifact that includes an instruction apparatus. The instruction apparatus implements a specified function in one or more processes in the flowcharts and/or in one or more blocks in the block diagrams.

These computer program instructions may also be loaded onto a computer or another programmable data processing device such that a series of operations and steps are performed on the computer or the other programmable device, thereby generating computer-implemented processing. Therefore, the instructions executed on the computer or the other programmable device provides steps for implementing a specified function in one or more processes in the flowcharts and/or in one or more blocks in the block diagrams.

Although some embodiments of the present application have been described, persons skilled in the art can make changes and modifications to these embodiments once they learn the basic inventive concept. Therefore, the following claims are intended to be construed as to cover the embodiments and all changes and modifications falling within the scope of the present application.

Obviously, persons skilled in the art can make various modifications and variations to the embodiments of the present application without departing from the spirit and scope of the embodiments of the present application. The present application is intended to cover these modifications and variations provided that they fall within the scope of protection defined by the following claims and their equivalent technologies.

What is claimed is:

1. A high dynamic range image processing method, comprising:
obtaining a high dynamic range image;
dividing the high dynamic range image into a first liquid crystal image and a first backlight image;
performing compression processing on the first liquid crystal image by decreasing a quantity of bits representing a single pixel of the first liquid crystal image to obtain a compressed first liquid crystal image to be displayed at a liquid crystal layer of a display, the display being configured to display the high dynamic range image; and
performing compression processing on the first backlight image by decreasing a quantity of bits representing a single pixel of the first backlight image to obtain a compressed first backlight image to be displayed at a backlight layer of the display.

2. The method of claim 1, wherein performing the compression processing on the first liquid crystal image comprises:
dividing the first liquid crystal image into at least two layers of second liquid crystal images, the at least two layers of second liquid crystal images comprising image information of the first liquid crystal image, and any two of the at least two layers of second liquid crystal images comprising different image information;
separately performing compression processing on the at least two layers of second liquid crystal images by decreasing a quantity of bits representing a single pixel of each of the at least two layers of second liquid crystal images; and
fusing compressed at least two layers of second liquid crystal images to obtain the compressed first liquid crystal image.

3. The method of claim 2, wherein the at least two layers of second liquid crystal images comprise two layers of second liquid crystal images, and decreasing the quantity of bits representing the single pixel of each of the at least two layers of second liquid crystal images comprising:
separately performing compression processing on pixel values of the two layers of second liquid crystal images based on different compression ratios; and
setting N bits to represent compressed pixel value of any pixel whose pixel value is compressed and of either of the two layers of second liquid crystal images to obtain two layers of compressed second liquid crystal images, the N comprising a positive integer less than a quantity of bits representing the any pixel whose the pixel value is compressed.

4. The method of claim 2, wherein the at least two layers of second liquid crystal images comprise a low-frequency second liquid crystal image, the low-frequency second liquid crystal image comprising low-frequency image information of the first liquid crystal image, and before decreasing the quantity of bits representing the single pixel of each of the at least two layers of second liquid crystal images, the method further comprising either:
performing dither processing on the low-frequency second liquid crystal image; or
performing global tone mapping processing on the low-frequency second liquid crystal image.

5. The method of claim 2, wherein the at least two layers of second liquid crystal images comprise a low-frequency second liquid crystal image, the low-frequency second liquid crystal image comprising low-frequency image information of the first liquid crystal image, and before decreasing the quantity of bits representing the single pixel of each of the at least two layers of second liquid crystal images, the method further comprising either:
performing global tone mapping processing on an image obtained after dither processing is performed on the low-frequency second liquid crystal image; or
performing the dither processing on an image obtained after the global tone mapping processing is performed on the low-frequency second liquid crystal image.

6. The method of claim 2, wherein before decreasing the quantity of bits representing the single pixel of each of the at least two layers of second liquid crystal images, the method further comprises either:
performing dither processing on the at least two layers of second liquid crystal images; or
performing global tone mapping processing on the at least two layers of second liquid crystal images.

7. The method of claim 2, wherein before decreasing the quantity of bits representing the single pixel of each of the at least two layers of second liquid crystal images, the method further comprises either:
separately performing global tone mapping processing on images obtained after dither processing is performed on the at least two layers of second liquid crystal images; or
separately performing the dither processing on images obtained after the global tone mapping processing is performed on the at least two layers of second liquid crystal images.

8. The method of claim 1, wherein obtaining the high dynamic range image comprises:
obtaining a to-be-processed image; and
setting the to-be-processed image as the high dynamic range image when a pixel bit quantity of the to-be-processed image is greater than a preset pixel bit quantity.

9. The method of claim 1, wherein obtaining the high dynamic range image comprises:
obtaining a to-be-processed image; and
performing dequantization processing on the to-be-processed image to obtain the high dynamic range image when a pixel bit quantity of the to-be-processed image is less than or equal to a preset pixel bit quantity.

10. The method of claim 1, wherein dividing the high dynamic range image into the first liquid crystal image and the first backlight image comprises:
performing backlight statistics collection on the high dynamic range image to obtain the first backlight image, a backlight value of any region in the high dynamic range image comprising a pixel value of a pixel in the first backlight image corresponding to the region;
increasing resolution of the first backlight image;
performing blurring processing on the first backlight image whose resolution is increased to obtain a second backlight image, the second backlight image simulating an image displayed after light diffusion processing is performed using an optical component in the display on the first backlight image when the first backlight image is displayed at the backlight layer; and
obtaining the first liquid crystal image by dividing the high dynamic range image based on the second backlight image.

11. A high dynamic range image processing apparatus, comprising:
a receiver configured to obtain a high dynamic range image;
a processor coupled to the receiver and configured to:
divide the high dynamic range image into a first liquid crystal image and a first backlight image;
perform compression processing on the first liquid crystal image by decreasing a quantity of bits representing a single pixel of the first liquid crystal image to obtain a compressed first liquid crystal image to be displayed at a liquid crystal layer of a display, the display being configured to display the high dynamic range image; and
perform compression processing on the first backlight image by decreasing a quantity of bits representing a single pixel of the first backlight image to obtain a compressed first backlight image to be displayed at a backlight layer of the display.

12. The apparatus of claim 11, wherein when performing the compression processing on the first liquid crystal image, the processor is further configured to:
divide the first liquid crystal image into at least two layers of second liquid crystal images, the at least two layers of second liquid crystal images comprising image information of the first liquid crystal image, and any two of the at least two layers of second liquid crystal images comprising different image information;
separately perform compression processing on the at least two layers of second liquid crystal images by decreasing a quantity of bits representing a single pixel of each of the at least two layers of second liquid crystal images; and
fuse compressed at least two layers of second liquid crystal images to obtain the compressed first liquid crystal image.

13. The apparatus of claim 12, wherein the at least two layers of second liquid crystal images comprise two layers of second liquid crystal images, and when decreasing the quantity of bits representing the single pixel of each of the at least two layers of second liquid crystal images, the processor being further configured to:
separately perform compression processing on pixel values of the at least two layers of second liquid crystal images based on different compression ratios; and
set N bits to represent compressed pixel value of any pixel whose pixel value is compressed and of either of the two layers of second liquid crystal images to obtain two layers of compressed second liquid crystal images, the N comprising a positive integer less than a quantity of bits representing the any pixel whose the pixel value is compressed.

14. The apparatus of claim 12, wherein the at least two layers of second liquid crystal images comprise a low-frequency second liquid crystal image, the low-frequency second liquid crystal image comprising low-frequency image information of the first liquid crystal image, and before decreasing the quantity of bits representing the single pixel of each of the at least two layers of second liquid crystal images, the processor being further configured to either:
perform dither processing on the low-frequency second liquid crystal image; or
perform global tone mapping processing on the low-frequency second liquid crystal image.

15. The apparatus of claim 12, wherein the at least two layers of second liquid crystal images comprise a low-frequency second liquid crystal image, the low-frequency second liquid crystal image comprising low-frequency image information of the first liquid crystal image, and before decreasing the quantity of bits representing the single pixel of each of the at least two layers of second liquid crystal images, the processor being further configured to either:
perform global tone mapping processing on an image obtained after dither processing is performed on the low-frequency second liquid crystal image; or
perform the dither processing on an image obtained after the global tone mapping processing is performed on the low-frequency second liquid crystal image.

16. The apparatus of claim 12, wherein before decreasing the quantity of bits representing the single pixel of each of the at least two layers of second liquid crystal images, the processor is further configured to either:
perform dither processing on the at least two layers of second liquid crystal images; or
perform global tone mapping processing on the at least two layers of second liquid crystal images.

17. The apparatus of claim 12, wherein before decreasing the quantity of bits representing the single pixel of each of the at least two layers of second liquid crystal images, the processor is further configured to either:
separately perform global tone mapping processing on images obtained after dither processing is performed on the at least two layers of second liquid crystal images; or
separately perform the dither processing on images obtained after the global tone mapping processing is performed on the at least two layers of second liquid crystal images.

18. The apparatus of claim 11, wherein the receiver is further configured to obtain a to-be-processed image, and the processor being further configured to set the to-be-processed image as the high dynamic range image when a pixel bit quantity of the to-be-processed image obtained by the receiver is greater than a preset pixel bit quantity.

19. The apparatus of claim 11, wherein the receiver is further configured to obtain a to-be-processed image, and the processor being further configured to perform dequantization processing on the to-be-processed image to obtain the high dynamic range image when a pixel bit quantity of the to-be-processed image obtained by the receiver is less than or equal to a preset pixel bit quantity.

20. The apparatus of claim 11, wherein when dividing the high dynamic range image into the first liquid crystal image and the first backlight image, the processor is configured to:
perform backlight statistics collection on the high dynamic range image to obtain the first backlight image, a backlight value of any region in the high dynamic range image comprising a pixel value of a pixel in the first backlight image corresponding to the region;
increase resolution of the first backlight image;
perform blurring processing on the first backlight image whose resolution is increased to obtain a second backlight image, the second backlight image simulating an image displayed after light diffusion processing is performed using an optical component in the display on the first backlight image when the first backlight image is displayed at the backlight layer; and
obtain the first liquid crystal image by dividing the high dynamic range image based on the second backlight image.
